(19) United States
(12) Patent Application Publication
(10) Pub. No.: US 2009/0249810 A1
(43) Pub. Date: Oct. 8, 2009

(54) EVAPORATOR

(76) Inventors: Dirk NEUMEISTER, Stuttgart (DE); Achim WIEBELT, Steinheim (DE); Juergen GRUENWALD, Ludwigsburg (DE)

Correspondence Address: Muncy, Geissler, Olds & Lowe, PLLC, P.O. BOX 1364, FAIRFAX, VA, 22038-1364, US

(21) Appl. No.: 12/417,491

(22) Filed: Apr. 2, 2009

(30) Foreign Application Priority Data
Apr. 2, 2008 (DE) 102008017113
Aug. 28, 2008 (DE) 102008044673

(51) Int. Cl. B60H 1/32; F28F 3/00; F25B 1/00

(52) U.S. Cl. 62/239; 165/167; 62/498

(57) ABSTRACT

An evaporator, in particular for a motor vehicle, is provided. The evaporator includes a plurality of plates stacked parallel to one another in a vertical direction with openings that are aligned with one another for supply and return of a first fluid in the form of refrigerant and of a second fluid, wherein there are formed between two adjacent plates a flow passage of a first type for carrying the first fluid in alternation with a flow passage of a second type for carrying the second fluid, wherein a heat-transferring area of the plates has a length in the direction of refrigerant flow and a width perpendicular thereto, wherein the ratio of the length to the width is no greater than approximately 1.3, wherein the refrigerant flows through the flow passages in a first bank comprising one or more of the flow passages of the first type, and at least one second bank comprising one or more of the flow passages of the first type following the first bank after a reversal of direction.

This nonprovisional application claims priority under 35 U.S.C. § 119(a) to German Patent Application Nos. DE 102008017113 and DE 102008044673, which were filed in Germany on Apr. 2, 2008 and Aug. 28, 2008, respectively, and which are both herein incorporated by reference.

### BACKGROUND OF THE INVENTION

1. Field of the Invention

The present invention relates to an evaporator, in particular for a motor vehicle. The invention also relates to a device for cooling a heat source of a motor vehicle.

2. Description of the Background Art

DE 10 2004 036 951 A1, which corresponds to U.S. Publication No. 20070107890, which is incorporated herein by reference, proposes using a heat exchanger constructed of parallel plates joined together, whose design is also known as a stacked-plate heat exchanger, as the evaporator of a refrigerating circuit in a motor vehicle. In this design, heat can be absorbed from a coolant flowing through the heat exchanger in the course of the evaporation of the refrigerant.

In a conventional plate-type heat exchanger used as an evaporator, it is necessary to make the plate length adequately long in the direction of refrigerant flow in order to ensure adequate evaporation and, in particular, to ensure adequate superheating of the evaporated refrigerant, with the result that the plate length is significantly greater in general than a plate width perpendicular to the direction of refrigerant flow. This results in limitations on the dimensioning of the evaporator as a function of the available installation space.

### SUMMARY OF THE INVENTION

It is therefore an object of the present invention to provide an evaporator that has an especially compact form and dimensions together with high heat exchanger performance and reliable superheating of the refrigerant.

This object is attained according to an embodiment of the invention by an evaporator, whereby as a result of a limitation of the ratio of length to width of the heat-transferring area to a value of less than or equal to 1.3, it is possible to achieve a plate-type evaporator that is especially short in the direction of refrigerant flow. In order to ensure adequate superheating of the refrigerant at the evaporator outlet in all operating situations with such a short design, and thus efficaciously prevent damage to a compressor of the refrigerating circuit caused by indrawn liquid refrigerant, it is also provided in accordance with the invention that the refrigerant flows through at least a first and a second bank of the evaporator. A bank can be understood to mean, for example, a flow path of the refrigerant that passes through the entire length of the evaporator, where successive banks generally run parallel to one another and in opposite directions so that the refrigerant undergoes a reversal of direction between the two successive banks. By means of the reversal of direction and the flow through successive banks, the flow path of the refrigerant in the evaporator is extended, even with a short configuration, so that adequate superheating can be ensured.

In an embodiment, the ratio of length to width L/B can be no less than approximately 0.5, in particular no less than approximately 0.7. As a result of such a choice for the ratios between length and width, the inventive evaporator can be made relatively short in design in every spatial direction, so that an especially compact configuration is made possible, in particular through roughly approaching a square outline of the individual exchanger plates.

In an embodiment of the invention, the relationship 1<=n2/n1<=3 can applied for the ratio of the number of flow passages in the second bank n2 to the number of flow passages in the first bank. This means that the number of flow passages in the second bank can be at least as great as the number of flow passages in the first bank, and may be up to 200% greater. As a result of the increase in the number of flow passages at the changeover from the first bank to the second bank, adequate superheating of the evaporating refrigerant is ensured in an especially reliable way.

Depending on the requirements, provision may be made in an embodiment for precisely two banks to be provided for the refrigerant. With regard to the refrigerant in such an embodiment with precisely two banks, it is useful for the heat exchanger to be designed as a U-flow heat exchanger.

In another embodiment of the invention, provision is made that the refrigerant flows through at least a third bank comprising one or more flow passages of the first type, which bank follows a second reversal of direction after the second bank. It is especially preferred here for the relationship 1<=n2/n1<=1.5 to apply for the ratio of the number of flow passages in the second bank n2 to the number of flow passages in the first bank n1. Alternatively or in addition, for such an embodiment with three banks, the relationship 1<=n3/n2<=3 applies for the ratio of the number of flow passages in the third bank n3 to the number of flow passages in the second bank n2, with it being especially preferred for both of the aforesaid relationships to apply. Consequently, the second bank has at least as many flow passages as the first bank and up to 50% more flow passages than the first bank. The third bank has at least as many flow passages as the second bank and up to 200% more flow passages than the second bank. By this means, the flow path of the refrigerant through the evaporator is further lengthened overall, with especially reliable superheating of the refrigerant at the outlet of the evaporator being achieved by the increase in the number of flow passages. Fundamentally, the additional provision of a fourth and further banks in the evaporator is not precluded within the scope of the invention.

Alternatively, and for the purpose of simple assembly of the evaporator, the number of flow passages in the first bank (n1) and the number of flow passages in the second bank (n2) and the number of flow passages in the third bank (n3) can be nearly the same or can be substantially identical (n1=n2=n3).

As a result of an identical number of flow passages in the three banks, the number of plates in the subsidiary stack for forming the three banks can also be identical. Consequently, it is not necessary to distinguish between the subsidiary stacks according to their later installed positions. Such a design of the evaporator considerably simplifies the logistics of production.

“Nearly the same” in the context of the invention means that a number of flow passages in one bank differs slightly from the number in the other two banks. For example, there may be six flow passages in the first and third banks, and seven in the second bank.

In order to improve the heat transfer between the two fluids, provision can be made such that the second fluid can flow through the evaporator in at least two banks, each of which comprises one or more of the flow passages of the second type. In the case of an embodiment with precisely two banks with respect to the second fluid, it would be useful to design the evaporator as a U-flow heat exchanger with respect to the second fluid. Alternatively, however, it can also be designed in a simple manner as an I-flow heat exchanger with only one bank for the second fluid. Depending on the requirements, more than two banks can also be provided for the second fluid. The second fluid can be generally a coolant, in particular a coolant in the liquid phase. Within the scope of the invention, the second fluid can also be a fluid that experiences a phase change between two physical states, in particular within the evaporator.

In a cost-saving and simple configuration of the invention, provision is made for a separation of successive banks to take the form of a special plate that is different from the other plates, which special plate has a barrier instead of one or more openings. By means of appropriate arrangement of special plates with such barriers, a multiple-bank evaporator in the design of a plate-type heat exchanger is produced. In an especially useful detailed design, the special plate has both a barrier for separating banks of the refrigerant and a barrier for separating banks of the second fluid. In this way, the number of special plates is kept particularly small, and the number of the other plates of the heat exchanger, which in general are designed as identical parts, is kept particularly large.

In an embodiment, no turbulence inserts are provided between the plates of an inventive evaporator. In addition to increased costs and labor-intensive manufacture, turbulence inserts pose the hazard of contaminating the refrigerant with flakes and other manufacturing residues of the turbulence inserts, which present the hazard of damage, especially in the case of connection to a refrigerating circuit having a compressor and expansion element. To increase the heat-transferring properties, embossing may be provided in the plates in place of separate turbulence inserts, the structure of the embossing achieves an increase in area and also the introduction of turbulence into the flowing fluids.

With regard to a spatial orientation of the evaporator, provision can be made for the direction of flow of the last of the banks to run essentially in the direction of gravity. In this way, it is possible to prevent refrigerant from collecting in the evaporator. “Essentially in the direction of gravity” should also be understood to mean any deviation from the precise direction of gravity that still permits sufficiently great influence of gravity on the outflow of the refrigerant.

The evaporator according to an embodiment of the invention is especially well suited for installation in a refrigerant circuit or the air conditioning system of a motor vehicle in order to cool a heat source of the motor vehicle through a coolant circuit. The compact form of the evaporator makes it possible to accommodate the ever tighter installation spaces in modern motor vehicles.

In an embodiment, the heat source can be a drive battery of the motor vehicle, in particular a lithium-ion battery. High demands on cooling are placed on such batteries, which are used not only in purely electric vehicles, but also in hybrid vehicles having an electric motor and an internal combustion engine, in order to ensure service life and operating reliability. A compact evaporator with high heat exchanger performance in accordance with the invention, which is located between a coolant circuit and a refrigerant circuit used in particular for climate control of the vehicle (also called a “chiller”) is especially suitable for this purpose.

Since the evaporator according to the invention ensures superheating of the refrigerant in its outlet region in an especially reliable manner, the compressor of the refrigerating circuit can usefully be arranged immediately after the second evaporator. This should be understood to mean, in particular, that no accumulator should be located between the evaporator and compressor, nor is any integrated accumulator provided in the evaporator for reasons of space.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a schematic representation of a conventional evaporator;

FIG. 2 shows a schematic sectional view of a first exemplary embodiment of an inventive evaporator;

FIG. 3 shows a schematic sectional view of a second exemplary embodiment of an inventive evaporator;

FIG. 4 shows a first example of a device for cooling a heat source with an inventive evaporator; and

FIG. 5 shows a modified version of the device from FIG. 4.

### DETAILED DESCRIPTION

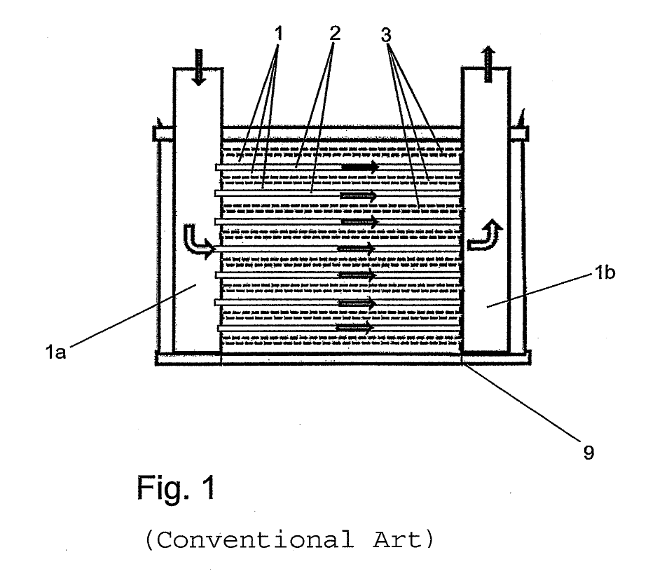

The schematic sectional representation in FIG. 1 shows an evaporator according to the conventional art. A plurality of plates 1 are stacked parallel to one another in a vertical direction h, with a flow passage of a first type 2 and a flow passage of a second type 3 remaining in alternation between every two plates. The plates 1 have openings 1a, 1b that are aligned with one another, by which are formed the tubular, vertically extending inlets and outlets for a refrigerant or first fluid and a second fluid of the evaporator. In order to separate the first and second types 2, 3 of flow passage from one another, the openings 1a, 1b have alternating raised edges (not shown) in a known manner, which are sealed to the adjacent plate by soldering. In an economical and useful manner, the plates are made of an aluminum alloy.

The stack of plates 1 is terminated at both its ends in a known manner by closing plates 9, to which are attached the supply lines and return lines for the refrigerant and the second fluid.

The flow of the refrigerant through the evaporator according to the prior art takes place in only one bank in the manner of an I-flow heat exchanger from the inlet 1a to the outlet 1b, as indicated by the arrows.

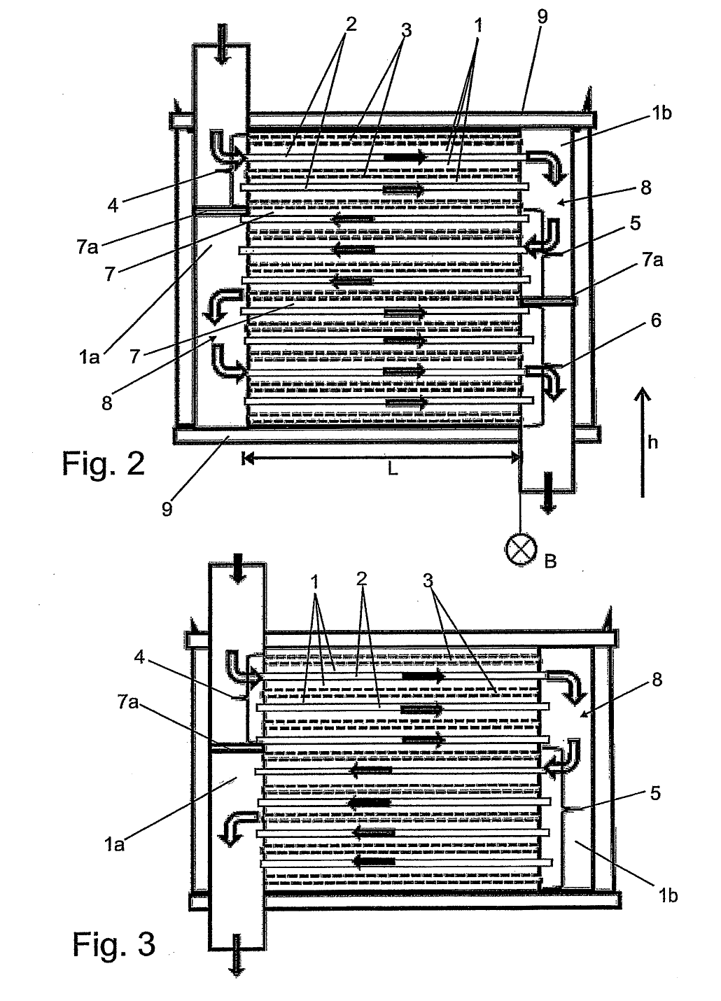

FIG. 2 shows a first exemplary embodiment of an evaporator, in which the evaporator is divided into a total of three banks 4, 5, 6 with respect to the refrigerant. The separation of the flow passages 1 into the individual banks 4, 5, 6 is accomplished by special plates 7, in which at least one of the openings 1a, 1b is replaced by a barrier 7a. The barriers 7a prevent full flow of the refrigerant through the inlets and outlets in the vertical direction. Due to the vertically offset arrangement of the barriers 7a, reversals of direction 8 are thus forced at the end of the first bank and at the end of the second bank, so that the refrigerant first flows parallel to a lengthwise direction in the first bank 4 from the inlet 1a to the side of the outlet 1b, is then redirected by 180°, then flows through the evaporator in the second bank 5 parallel to the lengthwise direction in the direction opposite the first bank, is then redirected again and flows through the evaporator in the third bank 6 parallel to the lengthwise direction and finally exits through the outlet 1b. The refrigerant in the evaporator thus follows an S-shaped flow path altogether.

A widthwise direction of the evaporator extends perpendicular to the plane of the drawing in FIG. 2, and thus perpendicular to the lengthwise direction and to the vertical direction h. Between the inlets and outlets 1a, 1b, the plates 1 have a heat-transferring area with a length L in the lengthwise direction and a width B in the widthwise direction. In the present example, L is approximately 4 cm and B is approximately 5.5 cm. This results in a ratio of L/B of approximately 0.73. A height H of the stack of plates 1 is approximately 4 cm. The outside dimensions of the evaporator for this concrete example are a total length of 8.8 cm, a total width of 6.2 cm, and a height of 4 cm.

The first bank 4 in the present example comprises a number n1 of two flow passages of the first type 2, the second bank 5 comprises a number n2 of three flow passages 2, and the third bank comprises a number n3 of four flow passages 2. Consequently, the following conditions apply for the ratios of the numbers of flow passages:

1<=n2/n1=1.5<=1.5 and

1<=n3/n2=1.33<=3.

Due to the increase in the particular number of flow passages 2 in successive banks 4, 5, 6, the expansion of the refrigerant is taken into account and, in particular, sufficient superheating of the refrigerant at the outlet of the evaporator is ensured.

No turbulence inserts are provided between the individual plates 1, at least on the refrigerant side. Depending on requirements, the plates 1 have embossing and structuring to increase the area and to introduce turbulence into the flowing refrigerant.

The flow passages of the second type 3 are represented by dashed lines, and in the present case a liquid coolant of a coolant circuit flows through them as a second fluid. The inlets and outlets for the second fluid are not shown.

FIG. 3 shows another embodiment of an inventive evaporator. In contrast to the exemplary embodiment from FIG. 2, the refrigerant here only flows through two banks 4, 5, so that the overall flow path of the refrigerant is U-shaped (U-flow heat exchanger). The dimensions of the plates 1 are the same as in the first exemplary embodiment.

In this example, the number of flow passages in the first bank 4 is n1=3, and the number of flow passages in the second bank 5 is n2=4. The number of flow passages thus fulfills the condition

1<=n2/n1=1.33<=3.

In another embodiment of the invention, the path of the coolant through the flow passages of the second type 3 is also subdivided into several banks. In particular, FIG. 3 shows a representation of the banks of the second fluid, or coolant, while the representation in FIG. 2 shows the banks of the refrigerant in the same evaporator. When both fluids are subdivided into multiple banks, provision can usefully be made for one or more of the special plates 7 to have both a barrier for the first fluid and a barrier for the second fluid. In this way, the number of necessary special plates can be reduced, and the total number of identical parts in the evaporator can be increased.

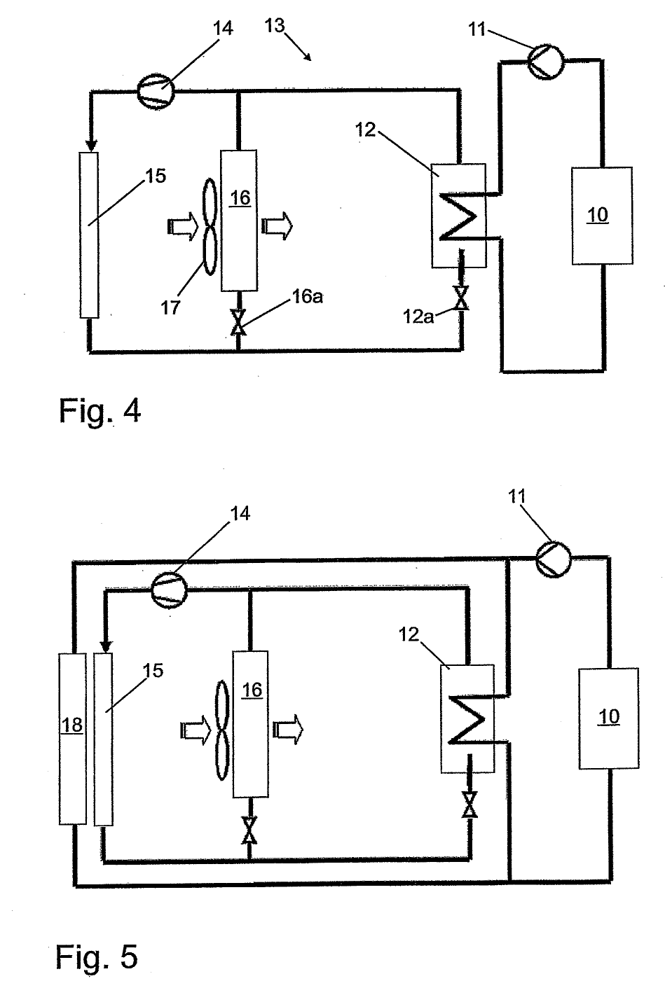

FIG. 4 shows a device for cooling a heat source 10 of a motor vehicle, in the present case a lithium-ion battery of a hybrid drive. The battery 10 is cooled by a circuit with liquid coolant, which is circulated by a circulating pump 11. The heat held by the battery 10 is carried away by a heat exchanger 12, which is an inventive evaporator according to one of the preceding exemplary embodiments.

The evaporator 12 is integrated in a refrigerating circuit 13, which at the same time is used for climate control of the motor vehicle. To this end, the refrigerant is compressed by a compressor 14, and subsequently cooled by a condenser or gas cooler 15. Connected in parallel after the condenser or gas cooler 15 are an air conditioning evaporator 16 and the inventive evaporator 12, wherein an expansion element 16a, 12a is located ahead of each evaporator 12, 16. A fan 17 moves air through the air conditioning evaporator 16 for conditioning.

Other wiring configurations of the evaporators 12, 16 are possible, such as in serial, in particular with switchable bypasses, for example. Likewise, a shared expansion element may be provided for the two evaporators 12, 16.

FIG. 5 shows a variation of the device from FIG. 4, in which the coolant circuit also has, in addition to the evaporator 16, an auxiliary cooler 18 wired in parallel, with outside air flowing around the cooler 18. Via valves (not shown), the coolant can flow through a choice of the evaporator 12, the cooler 18, or the two heat exchangers 12, 18, in order to ensure optimum cooling of the battery 10 and the vehicle interior in all operating conditions.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. An evaporator comprising:
a plurality of plates stacked parallel to one another in a vertical direction with openings that are aligned with one another for supply and return of a first fluid and of a second fluid, the first fluid being a refrigerant; and
a flow passage of a first type formed between two adjacent plates for carrying the first fluid in alternation with a flow passage of a second type for carrying the second fluid;
wherein a heat-transferring area of the plates has a length in a direction of refrigerant flow and a width perpendicular thereto,
wherein the ratio of the length to the width is no greater than approximately 1.3, and
wherein the refrigerant flows through the flow passages in a first bank comprising one or more of the flow passages of the first type and at least one second bank comprising one or more of the flow passages of the first type following the first bank after a reversal of direction of the refrigerant.

2. The evaporator according to claim 1, wherein the ratio of the length to the width is no less than approximately 0.5 or no less than approximately 0.7.

3. The evaporator according to claim 1, wherein a relationship 1<=n2/n1<=3 applies for a ratio of a number of flow passages in the second bank to the number of flow passages in the first bank.

4. The evaporator according to claim 3, wherein precisely two banks are provided for the refrigerant.

5. The evaporator according to claim 1, wherein the refrigerant flows through a third bank comprising one or more flow passages of the first type, the third bank following a second reversal of direction of the refrigerant after the second bank.

6. The evaporator according to claim 5, wherein the relationship 1<=n2/n1<=1.5 applies for a ratio of a number of flow passages in the second bank to the number of flow passages in the first bank.

7. The evaporator according to claim 5, wherein the relationship 1<=n3/n2<=3 applies for a ratio of a number of flow passages in the third bank to the number of flow passages in the second bank.

8. The evaporator according to claim 5, wherein a number of flow passages in the third bank and a number of flow passages in the second bank and a number of flow passages in the first bank are nearly the same or are identical.

9. The evaporator according to claim 1, wherein the second fluid flows through the evaporator in at least two banks, each of which comprises one or more of the flow passages of the second type.

10. The evaporator according to claim 1, wherein a special plate that is different from the other plates separates successive banks, and wherein the special plate has a barrier instead of one or more of the openings.

11. The evaporator according to claim 10, wherein the special plate has both a barrier for separating banks of the refrigerant and a barrier for separating banks of the second fluid.

12. The evaporator according to claim 1, wherein the evaporator has a spatial orientation in which the direction of flow of the last of the banks runs essentially in a direction of gravity.

13. A device for cooling a heat source of a motor vehicle, the device comprising:
a refrigerating circuit having a compressor, a condenser or gas cooler, a first evaporator for air conditioning a passenger compartment, and a second evaporator,
wherein the second evaporator is configured to thermally exchange with a coolant circuit that cools the heat source, and
wherein the second evaporator is an evaporator comprising:
a plurality of plates stacked parallel to one another in a vertical direction with openings that are aligned with one another for supply and return of a first fluid and of a second fluid, the first fluid being a refrigerant; and
a flow passage of a first type formed between two adjacent plates for carrying the first fluid in alternation with a flow passage of a second type for carrying the second fluid;
wherein a heat-transferring area of the plates has a length in a direction of refrigerant flow and a width perpendicular thereto,
wherein the ratio of the length to the width is no greater than approximately 1.3, and
wherein the refrigerant flows through the flow passages in a first bank comprising one or more of the flow passages of the first type and at least one second bank comprising one or more of the flow passages of the first type following the first bank after a reversal of direction of the refrigerant

14. The device according to claim 13, wherein the heat source is a drive battery or a lithium-ion battery of the motor vehicle.

15. The device according to claim 13, wherein the compressor is arranged immediately after the second evaporator in the refrigerating circuit.

16. The evaporator according to claim 1, wherein the evaporator is configured to be received in a motor vehicle.
